(19) United States
(12) Patent Application Publication
(10) Pub. No.: US 2007/0298977 A1
(43) Pub. Date: Dec. 27, 2007

(54) Degradable particulate generation and associated methods

(75) Inventors: Michael N. Mang, Eden Prairie, MN (US); Trinidad Munoz JR., Duncan, OK (US); Rajesh K. Saini, Duncan, OK (US)

Correspondence Address: Robert A. Kent, 2600 S. 2nd Street, Duncan, OK, 73536-0440, US

(73) Assignee: Halliburton Energy Services, Inc.

(21) Appl. No.: 11/049,600

(22) Filed: Feb. 2, 2005

(51) Int. Cl. C09K 8/60; C08F 6/22

(52) U.S. Cl. 507/219

(57) ABSTRACT

Herein provided are methods for producing degradable particulates at a drill site, and methods related to the use of such degradable particulates in subterranean applications. In one embodiment, the present invention provides a method comprising: providing a treatment fluid, the treatment fluid comprising degradable particulates, the degradable particulates having been made by an emulsion method at a drill site; and introducing the treatment fluid into a well bore penetrating a subterranean formation at the drill site.

### BACKGROUND

The present invention relates generally to facilitating the use of degradable particulates. More particularly, the present invention relates to methods for producing degradable particulates at a drill site, and methods related to the use of such degradable particulates in subterranean applications.

Degradable particulates comprise degradable materials (which are oftentimes degradable polymers) that are capable of undergoing an irreversible degradation when used in subterranean applications, e.g., in a well bore. As used herein, the terms “particulate” or “particulates” refer to a particle or particles that may have a physical shape of platelets, shavings, fibers, flakes, ribbons, rods, strips, spheroids, toroids, pellets, tablets, or any other suitable shape. The term “irreversible” as used herein means that the degradable material should degrade in situ (e.g., within a well bore) but should not recrystallize or reconsolidate in situ after degradation (e.g., in a well bore). The terms “degradation” or “degradable” refer to both the two relatively extreme cases of hydrolytic degradation that the degradable material may undergo, e.g., heterogeneous (or bulk erosion) and homogeneous (or surface erosion), and any stage of degradation in between these two. This degradation can be a result of, inter alia, a chemical or thermal reaction, or a reaction induced by radiation. The terms “polymer” or “polymers” as used herein do not imply any particular degree of polymerization; for instance, oligomers are encompassed within this definition.

The degradability of a degradable polymer often depends, at least in part, on its backbone structure. For instance, the presence of hydrolyzable and/or oxidizable linkages in the backbone often yields a material that will degrade as described herein. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, presence of moisture, oxygen, microorganisms, enzymes, pH, and the like.

The physical properties of degradable polymers depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, inter alia, extensional viscosity with tension-stiffening behavior. The properties of the material utilized can be further tailored by blending, and copolymerizing it with another polymer, or by changing the macromolecular architecture (e.g., hyper-branched polymers, star-shaped, or dendrimers, etc.). The properties of any such suitable degradable polymers (e.g., hydrophobicity, hydrophilicity, rate of degradation, etc.) can be tailored by introducing select functional groups along the polymer chains. For example, poly(phenyl)actide) will degrade at about one fifth of the rate of racemic poly(lactide) at a pH of 7.4 at 55° C.

To obtain degradable particulates that may be used in subterranean applications (e.g., as acid precursors, fluid loss control particles, diverting agents, filter cake components, drilling fluid additives, cement additives, etc.), off-site processes may be used wherein the degradable particulates are manufactured and then those particulates are transported to a drill site for use. Common manufacturing processes include cryogenic grinding, which is an expensive process that involves grinding a degradable polymer, such as poly(lactic acid), at cryogenic temperatures to form particulates having a desired shape and size. Oftentimes, these grinding processes are inefficient, requiring multiple passes through equipment, usually resulting in corresponding yield losses. Also, mechanical classification (e.g., mechanical classification to separate different size particulates to obtain a specific size distribution) often is required to obtain narrow particle size distributions, which generally are desired. Another method that may be used to make degradable particulates off-site is spray drying. Spray drying processes usually involve dissolution of a degradable polymer sample in a volatile solvent (which can be an environmental problem itself), and spraying the solution into a stream of hot gas to make degradable particulates. Such processes generally need to be carried out in a specially designed factory setting, and the large scale production of degradable particulates may not be practicable. Another method of producing degradable particulates is an extrusion method; however, extrusion methods generally are not useful for making degradable particulates that are less than about 500 microns in size.

One problem with making degradable particulates off-site to be used in subterranean applications that are located at drill sites is that the ability to respond to changes in conditions that are encountered in a particular application is hampered because there is no flexibility to change the composition or properties of the particulates once they are at the drill site. This may be problematic, for instance, if the conditions of a particular application dictate that certain degradable particulates should be used to obtain a given result. One example is where it may be desirable to change the particle size distribution of the degradable particulates for a fluid loss control operation. If the particulates are not made at the drill site, then the operator has a limited ability to alter that characteristic of the degradable particulates. Thus, operators are unable to respond to conditions encountered during subterranean conditions in terms of providing the most desirable degradable particulates for that application.

Moreover, transportation of degradable particulates made in an off-site process to a drill site may be especially problematic. The conditions encountered while shipping may pose hazards to the degradable particulates that may negatively impact their properties or characteristics.

### SUMMARY

The present invention relates generally to facilitating the use of degradable particulates. More particularly, the present invention relates to methods for producing degradable particulates at a drill site, and methods related to the use of such degradable particulates in subterranean applications.

In one embodiment, the present invention provides a method comprising:

providing a degradable polymer solvent mixture that comprises a degradable polymer and a first solvent; adding the degradable polymer solvent mixture to a second solvent with sufficient shear to form an emulsion at a drill site, the emulsion comprising a discontinuous phase and a continuous phase, the discontinuous phase comprising the degradable polymer solvent mixture and the continuous phase comprising the second solvent; removing a sufficient amount of the first solvent from the discontinuous phase so that degradable particulates begin to form; and allowing a dispersion of degradable particulates to form in the continuous phase.

In one embodiment, the present invention provides a method comprising: providing a degradable polymer solvent mixture that comprises a degradable polymer and a first solvent; adding the degradable polymer solvent mixture to a second solvent with sufficient shear to form an emulsion at a drill site, the emulsion comprising a discontinuous phase and a continuous phase, the discontinuous phase comprising the degradable polymer solvent mixture and the continuous phase comprising the second solvent; and allowing a dispersion of degradable particulates to form in the continuous phase.

In another embodiment, the present invention provides a method comprising: providing a treatment fluid, the treatment fluid comprising degradable particulates, the degradable particulates having been made by an emulsion method at a drill site; and introducing the treatment fluid into a well bore penetrating a subterranean formation at the drill site.

The features and advantages of the present invention will be readily apparent to those skilled in the art upon a reading of the description of the embodiments that follows.

### DESCRIPTION

The present invention relates generally to facilitating the use of degradable particulates. More particularly, the present invention relates to methods for producing degradable particulates at a drill site, and methods related to the use of such degradable particulates in subterranean applications.

The present invention provides methods of generating degradable particulates at a drill site. The term drill site, as used herein, refers to the workplace at the site of a drill hole (sometimes referred to as a well bore or borehole) before, during, and after production. The degradable particulates can be made at the drill site for use in a well bore located at the drill site. In certain embodiments, the degradable particulates may be made and then stored at the drill site until a desired time for use. In other embodiments of this invention, the degradable particulates can be made at the drill site and then used relatively quickly in a chosen subterranean application. The storability of the degradable particulates made, and the particular application in which they will be used, likely will dictate whether storage or immediate use is preferred. One of the many advantages offered by the methods and compositions of the present invention is the ability to modify the degradable particulates to respond to changes in conditions and requirements. For instance, the particle size distribution or relative pliability could be modified based on the particular subterranean conditions encountered. Another advantage is that transportation costs and conditions that may harm the degradable particulates may be avoided and/or reduced. Examples of subterranean applications in which the generated degradable particulates could be used include, but are not limited to, such applications as fluid loss control particles, as diverting agents, as filter cake components, as drilling fluid additives, as cement composition additives, or other acid-precursor components.

The degradable particulates made in conjunction with a method of the present invention can be placed into a subterranean formation with or without a treatment fluid, or they may be stored in a suitable collection container located at or near the drill site for use at a desired time, depending on the storability of the particulates. As used herein, the term “treatment fluid” refers to any fluid that may be used in a subterranean application in conjunction with a desired function and/or for a desired purpose. The term “treatment fluid” does not imply any particular action by the fluid or any component thereof. In some embodiments, a particular treatment fluid with which the degradable particulates will be placed into a well bore may be incorporated into a method of making the degradable particulates, e.g., as a solvent or fluid in the process. The degradable particulates may have differing properties, such as, relative hardness, pliability, degradation rate, etc. depending on the processing factors, the type of degradable polymer used, etc. The specific properties of the degradable particulates produced may vary by varying certain process parameters (including compositions), which will be evident to one of ordinary skill in the art with the benefit of this disclosure.

The methods of this invention include emulsion methods, precipitation methods, melt coagulation methods, and supercritical fluid assisted methods.

### The Emulsion Methods of This Invention

The present invention provides emulsion methods that may be used to generate degradable particulates of a suitable or desirable size and shape at a drill site for use in subterranean applications. The degradable particulates can be used in a subterranean application with or without a treatment fluid, depending on the use.

Generally, certain embodiments of the emulsion methods of this invention comprise providing a degradable polymer solvent mixture that comprises a degradable polymer and a first solvent; adding the degradable polymer mixture to a second solvent with sufficient shear to form an emulsion that comprises a discontinuous phase and a continuous phase, the discontinuous phase comprising the degradable polymer mixture and the continuous phase comprising the second solvent; removing a sufficient amount of the first solvent from the discontinuous phase so that degradable particulates begin to form; and allowing a dispersion of degradable particulates to form in the continuous phase. The first solvent can be removed from the degradable polymer mixture in the discontinuous phase by any suitable process including, but not limited to, vacuum stripping, steam stripping, evaporation, and the like. Any suitable shearing device may be used in these methods including, but not limited to, high speed dispersers, jet nozzles, in-line mixers, and the like.

In alternative embodiments, the emulsion methods of this invention involve providing a degradable polymer solvent mixture; adding a second solvent to the degradable polymer solvent mixture with sufficient shear to form a first emulsion, the first emulsion comprising a discontinuous phase that comprises the second solvent and a continuous phase that comprises the degradable polymer solvent mixture; continuing to add the second solvent to the first emulsion until phase inversion occurs to form a second emulsion, the second emulsion comprising a discontinuous phase that comprises the degradable polymer solvent mixture and a continuous phase that comprises the second solvent; remove the first solvent from the discontinuous phase of the second emulsion so that degradable particulates begin to form; and allowing a dispersion of degradable particulates to form in the continuous phase of the second emulsion. The first solvent can be removed from the degradable polymer mixture in the discontinuous phase by any suitable process including, but not limited to, vacuum stripping, steam stripping, evaporation, and the like. Any suitable shearing device may be used in these methods including, but not limited to, high speed dispersers, jet nozzles, in-line mixers, and the like.

The resultant degradable particulates can be used in a subterranean application with or without a treatment fluid, depending on the use. In some embodiments, the second solvent may be the treatment fluid. This may be beneficial when a high concentration of degradable particulates in the fluid is desired. In alternative embodiments, the degradable particulates can be made in a batch process at the drill site and then at a desired time, they may be added to a process stream to be placed in a subterranean formation. This method may be useful when a lower concentration of degradable particulates is desired for the application.

The important aspect to keep in mind with respect to the emulsion methods of the present invention is that the first solvent and the second solvent should be immiscible.

The degradable polymer solvent mixture may be any suitable type of mixture of a degradable polymer and a solvent including, but not limited to, a solution, a suspension, or an emulsion. In one embodiment, the degradable polymer solvent mixture may be formed by forming a degradable monomer solvent mixture (which may be an emulsion, a solution, or a suspension), and then reacting the degradable monomer solvent mixture to polymerize the monomer to form a degradable polymer solvent mixture that may be used to form degradable particulates. One of ordinary skill in the art with the benefit of this disclosure will recognize the amount of heat or a suitable catalyst will be needed to affect polymerization. One consideration will be the type of monomer and solvent used. Any suitable heating device may be used.

Examples of suitable degradable polymers that may be used in conjunction with the emulsion methods of this invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters, polyester amides, polyamides, and copolymers or blends of any of these degradable polymers. The term “copolymer” as used herein is not limited to the combination of two polymers, but includes any combination of polymers, e.g., terpolymers and the like. Of these suitable polymers, aliphatic polyesters such as poly(lactic acid), poly(anhydrides), poly(orthoesters), and poly(lactide)-co-poly(glycolide) copolymers are preferred. Poly(lactic acid) is especially preferred. Poly(orthoesters) also may be preferred. Other degradable polymers that are subject to hydrolytic degradation also may be suitable. One's choice may depend on the particular application and the conditions involved. Other guidelines to consider include the degradation products that result, the time for required for the requisite degree of degradation, and the desired result of the degradation (e.g., voids). Others that are preferred include those degradable polymers that release useful or desirable degradation products that are desirable, e.g., an acid. Such degradation products may be useful in a downhole application, e.g., to break a viscosified treatment fluid or an acid soluble component present therein (such as in a filter cake).

Preferred aliphatic polyesters have the general formula of repeating units shown below: 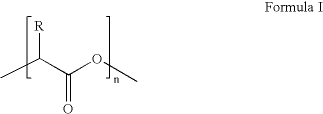
where n is an integer between 75 and 10,000 and R is a hydrogen, alkyl, aryl, alkylaryl, acetyl, heteroatoms, or mixtures thereof. Of these aliphatic polyesters, poly(lactide) is preferred. Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to formula I without any limitation as to how the polymer was made such as from lactides, lactic acid, or oligomers, and without reference to the degree of polymerization or level of plasticization. The lactide monomer exists generally in three different forms: two stereoisomers L- and D-lactide and racemic D,L-lactide (meso-lactide). The oligomers of lactic acid, and oligomers of lactide are defined by the formula: 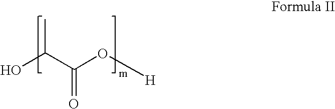
where m is an integer 2≦m≦75. Preferably m is an integer and 2≦m≦10. These limits correspond to number average molecular weights below about 5,400 and below about 720, respectively. The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications of the present invention where a slower degradation of the degradable particulates is desired. Poly(D,L-lactide) may be a more amorphous polymer with a resultant faster hydrolysis rate. This may be suitable for other applications where a more rapid degradation may be appropriate. The stereoisomers of lactic acid may be used individually or combined to be used in accordance with the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified to be used in the present invention by, inter alia, blending, copolymerizing or otherwise mixing the stereoisomers, blending, copolymerizing or otherwise mixing high and low molecular weight poly(lactides), or by blending, copolymerizing or otherwise mixing a poly(lactide) with another polyester or polyesters.

Plasticizers may be included in the degradable polymers of the present invention. The plasticizers may be present in an amount sufficient to provide the desired characteristics, for example, a desired tackiness to the generated degradable particulates. In addition to the other qualities above, the plasticizers may enhance the degradation rate of the degradable polymeric materials. The plasticizers, if used, are preferably at least intimately incorporated within the degradable polymers. An example of a suitable plasticizer for poly(lactide) would include oligomeric lactic acid. Examples of plasticizers useful for this invention include, but are not limited to, polyethylene glycol; polyethylene oxide; oligomeric lactic acid; citrate esters (such as tributyl citrate oligomers, triethyl citrate, acetyltributyl citrate, and acetyltriethyl citrate); glucose monoesters; partially fatty acid esters; PEG monolaurate; triacetin; poly(ε-caprolactone); poly(hydroxybutyrate); glycerin-1-benzoate-2,3-dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations thereof. The choice of an appropriate plasticizer will depend on the particular degradable polymer utilized. It should be noted that, in certain embodiments, when initially formed, the degradable particulates may be somewhat pliable. But once substantially all of the solvent has been removed, the particulates should harden. More pliable degradable particulates may be beneficial in certain chosen applications. The addition of presence of a plasticizer can affect the relative degree of pliability. Also, the relative degree of crystallinity and amorphousness of the degradable polymer can affect the relative hardness of the degradable particulates.

In some of these emulsion method embodiments, to form an emulsion, any emulsifying surfactant capable of forming an emulsion of a degradable polymer solvent mixture and the second solvent may be included. Examples of suitable emulsifying surfactants include any cationic, anionic, or nonionic surfactant capable of forming an emulsion as described herein. Specific examples include, but are not limited to, sodium dodecyl sulfate, poly(vinyl alcohol), sodium dodecylbenzenesulfonic acid, cetyltrimethylammonium bromide, cetylpyridinium bromide, hexadecylmaltoside, Triton™ X-100, Tween™ 20, Brij W1, and Tergitol™ NP-40. Polyvinyl alcohol is a preferred surfactant when water is used as a continuous phase solvent. Other emulsifying surfactants include free fatty acids, esters of fatty acids, with polyoxalkylene compounds (like polyoxyethylene glycol, fatty acid esters with sorbitan, soaps, etc.). The choice of which particular emulsifying surfactant to use may be determined by the particular degradable polymer, first solvent, and second solvent used in any given embodiment. In certain embodiments, the emulsifying surfactant should be included in an amount sufficient to stabilize the emulsion. In some embodiments, this may be from about 0.1% to about 5% by weight of the continuous phase. The amount of emulsifying surfactant to include may depend on the identify of the degradable polymer; the identities of the first solvent and second solvent; the particular surfactant used and how well that surfactant stabilizes the emulsion; and the ability of the particular emulsifying surfactant chosen to potentially help prevent the agglomeration of degradable particulates once formed.

The choice of first solvent for the degradable polymer solvent mixture in the emulsion methods of this invention will depend primarily on its interaction with the chosen second solvent. The first solvent and the second solvent in the emulsion methods should be immiscible, and therefore, should be chosen vis-à-vis the other. Other guidelines useful for choosing a first solvent include, inter alia, the particular degradable polymer chosen, the emulsifying surfactant used, the concentration of the degradable polymer in the degradable polymer solvent mixture, and other similar factors. Examples include, but are not limited to, acetone, chloroform, dichloromethane, 1,2-dichlorobenzene, tetrahydrofuran, benzene, acetonitrile, dioxane, dimethylformamide, toluene, ethyl acetate, N-methylpyrrolidone, xylene, ether, diphenyl ether, ethylbenzene, naphthalene, propylene carbonate, di(propylene glycol) methyl ether, di(propylene glycol) propyl ether, di(propylene glycol) butyl ether, di(propylene glycol) methyl ether acetate, derivatives thereof, and combinations thereof. If the degradable polymer used is poly(lactic acid), then a preferred solvent may be dichloromethane or chloroform, depending on the surrounding circumstances. Other considerations to be taken into account when choosing a first solvent include safety and industrial hygiene, any potential environmental issues, potential safety issues in terms of flash point and potential exposure, and relative cost. The first solvent should be included in an amount sufficient so that the degradable polymer solvent mixture has a low enough viscosity such that when it is added to the second solvent with shear, the degradable polymer solvent mixture forms a discontinuous phase in the second solvent. This amount will vary based on several characteristics including, the particular degradable polymer utilized, the molecular weight of the degradable polymer, the concentration of the degradable polymer in the degradable polymer solvent mixture, and the like. One of ordinary skill in the art with the benefit of this disclosure will be able to recognize the appropriate amount to include taking into account these considerations. Preferably, a minimal amount of the first solvent should be used where possible because that solvent will be removed to form degradable particulates. In preferred embodiments, the first solvent should be substantially removed from the degradable polymer emulsion discontinuous phase to allow degradable particulates to form in a more beneficial manner. In certain embodiments, the amount of first solvent included will range from about 5% to about 80% based on the amount of the degradable polymer that is included in the degradable polymer solvent mixture. In one example of one embodiment wherein poly(lactic acid) is used, dichloromethane may be used in an amount of 50% to 80% based on the weight of poly(lactic acid) used.

Second solvents should be chosen relative to the first solvent such that the first solvent and second solvent are immiscible. Suitable examples of second solvents that may be used in the emulsion methods of this invention include any fluid in which the degradable polymer is relatively insoluble and that is capable of interacting with the first solvent in such a way as to allow ultimately at least partially removal of the first solvent from the degradable polymer emulsion discontinuous phase so that degradable particulates may form in the second solvent. Preferred second solvents are aqueous-based. Suitable aqueous-based fluids may comprise a water source such as fresh water, saltwater (e.g., water containing one or more salts dissolved therein), brine (e.g., saturated saltwater), or seawater. Generally, the water source can be from any source, provided that it does not contain an excess of compounds that may adversely affect the degradable polymer emulsion and/or the formation of degradable particulates. Potentially problematic compounds to be mindful of will be evident to one skilled in the art with the benefit of this disclosure. Examples of nonaqueous second solvents that may be used include ethanol, isopropanol, and polyhydric alcohols such as glycerol. As stated above, the second solvent may be a treatment fluid that will be introduced into the subterranean formation (e.g., a fracturing fluid, a gravel pack fluid, a drilling fluid, etc.). Thus, in such embodiments, the resultant degradable particulates may be introduced into the subterranean formation with the second solvent, which would be the treatment fluid used in that particular application. The second solvent should be included in an embodiment of the emulsion methods of this invention in an amount sufficient to aid in the removal of the first solvent from the degradable polymer so that degradable particulates form and in at least an amount sufficient to form an adequate emulsion. The amount of second solvent to use may vary depending on certain factors, for example, the desired characteristics of the resultant degradable particulates; the concentration of the degradable polymer solvent mixture in the second solvent; the concentration of the degradable polymer in the degradable polymer solvent mixture, and the amount of degradable particulates to be produced. In some embodiments, the amount of second solvent to include may be less than about 1% to more than about 95% relative to the emulsion. To ensure that desirable degradable particulates form, the degradable polymer should not be soluble in the second solvent.

If desired, optionally additives such as oxidizers, salts, or other chemical agents may be included such that when the degradable particulates form, the additives become incorporated within the particulates. Any additive that is capable of becoming incorporated into the degradable particulates during the emulsion process may be used. Any such additives may have a specific desirable functionality. For example, some additives may modulate the rate of hydrolysis of the degradable particulates depending on the conditions encountered in the particular application. Including an additive may be desirable when it would be beneficial to introduce the additive into the subterranean formation upon or during degradation of the degradable particulates. When contemplating the addition of an additive, one should be mindful that the additive should not adversely affect other operations or components. In an example of an alternative embodiment, an acid-soluble solid material may be added to the degradable polymer emulsion so that the acid-soluble material becomes incorporated into the resultant degradable particulates. Examples of suitable acid-soluble solid materials include, but are not limited to, calcium carbonate and magnesium oxide. This may be desirable, for example, to neutralize the acid generated upon degradation of the degradable particulates, to modulate the hydrolysis of the degradable particulates, or to add crush strength to the degradable particulates.

In these embodiments, the average size distribution of the resultant degradable particulates may vary, depending on several factors. These factors include, but are not limited to, the type of emulsifying surfactant used, the amount of emulsifying surfactant used, the type of first solvent used, the type of second solvent used, the chemical interaction between the first solvent and the second solvent, the particular degradable polymer used, the molecular weight of the degradable polymer, the concentration of the degradable polymer in the degradable polymer solvent mixture; the amount of shear applied; the presence of certain additives, the temperature conditions, etc. The desired average particulate size distribution can be modified as desired by modifying any of these factors. One of ordinary skill in the art with the benefit of this disclosure will be able to identify the particular factor to modify to achieve a desired particulate size distribution.

### The Precipitation Methods of This Invention

The present invention provides precipitation methods that may be used to generate degradable particulates of a suitable or desirable size and shape at a drill site for use in subterranean applications. The degradable particulates can be used in a subterranean application with or without a treatment fluid, depending on the use.

A method for forming degradable particulates at a drill site comprises: providing a degradable polymer solvent mixture that comprises a degradable polymer and a first solvent; and mixing the degradable polymer solvent mixture in a second solvent with shear to form a solid liquid dispersion comprising a solid phase and a liquid phase, the solid phase comprising degradable particulates and the liquid phase comprising the first solvent and the second solvent. In these precipitation methods, the first solvent and the second solvent should be soluble in each other. Most preferably, the first solvent should be more soluble in the second solvent than the degradable polymer. As a result of, inter alia, this solubility the first solvent should go from the degradable polymer solvent mixture to the second solvent without an additional removal step.

Any suitable shearing device may be used in these methods including, but not limited to, high speed dispersers, jet nozzles, in-line mixers, and the like. The shearing device chosen should generate sufficient shear so that the solid-liquid dispersion forms. One should note that the particle size distribution of the resultant degradable particulates may be a function of the shearing device and the amount of shear used. For instance, more or stronger shear may result in smaller particulates, depending on the degradable polymer utilized.

The resultant degradable particulates can be used in a subterranean application with or without a treatment fluid, depending on the use. In some embodiments, the second solvent may be the treatment fluid. This may be beneficial when a high concentration of degradable particulates in the fluid is desired. In alternative embodiments, the degradable particulates can be made in a batch process at the drill site and then at a desired time, they may be added to a process stream to be placed in a subterranean formation. A batch method may be useful when a lower concentration of degradable particulates is desired for the application.

The important aspect to keep in mind with respect to the precipitation methods of the present invention is that the first solvent should be soluble in the second solvent, and the degradable polymer used should not be soluble in the second solvent.

The degradable polymer solvent mixture may be any suitable type of mixture of a degradable polymer and a solvent including, but not limited to, a solution, a suspension, or an emulsion. In one embodiment, the degradable polymer solvent mixture may be formed by forming a degradable monomer solvent mixture (which may be an emulsion, a solution, or a suspension), and then reacting the degradable monomer solvent mixture to polymerize the monomer to form a degradable polymer solvent mixture that may be used to form degradable particulates. One of ordinary skill in the art with the benefit of this disclosure will recognize the amount of heat, catalyst, or time will be needed to affect polymerization. One consideration will be the type of monomer and solvent used. Any suitable heating device may be used.

In some embodiments, it may be desirable to add a surfactant at some point in the precipitation process, e.g., in the solid-liquid dispersion. Adding a surfactant may help prevent agglomeration of the resultant degradable particulates. In some embodiments, the precipitation methods may be relatively slower than the emulsion methods, which may result in the degradable particulates being more tacky and liable to agglomerate. If more pliable or tacky particulates are desired for a given application, then a precipitation method of this invention may be most suitable. Examples of suitable emulsifying surfactants include any cationic, anionic, or nonionic surfactant capable of preventing agglomeration of the particulates. Specific examples include, but are not limited to, sodium dodecyl sulfate, poly(vinyl alcohol), sodium dodecylbenzenesulfonic acid, cetyltrimethylammonium bromide, cetylpyridinium bromide, hexadecylmaltoside, Triton™ X-100, Tween™ 20, Brij W1, and Tergitol™ NP-40. The choice of which particular surfactant to use may be determined by the particular degradable polymer, first solvent, and second solvent used in any given embodiment. In certain embodiments, the surfactant should be included in an amount sufficient to prevent degradable particulate agglomeration. In some embodiments, this may be from about 0.1% to about 5% based on the amount of the second solvent.

The same degradable polymers are suitable for these methods as those listed and discussed above with respect to the emulsion methods of the present invention. Examples of suitable degradable polymers that may be used in conjunction with these methods include, but are not limited to, aliphatic polyesters; poly(lactides); poly(hydroxy ester ethers); poly(glycolides); poly(ε-caprolactones); poly(hydroxybutyrates); poly(anhydrides); polycarbonates; poly(orthoesters); poly(amino acids); poly(ethylene oxides); poly(phosphazenes); poly ether esters; polyester amides; polyamides; and copolymers or blends of any of these degradable polymers. Other degradable polymers that are subject to hydrolytic degradation also may be suitable.

Plasticizers as discussed above with respect to the emulsion methods of this invention may be included in the degradable polymers, if desired. One should note though to achieve the most beneficial effects of this invention, it is preferred that the plasticizers should not be soluble in the second solvent.

Additionally, the same suitable first solvents as those described above with respect to the emulsion methods of the present invention are suitable for use in the precipitation methods of this invention. In these precipitation methods, one should remember that the first solvent should be chosen relative to the second solvent such that the first solvent is soluble in the second solvent. It also is preferred that the first solvent be capable of at least partially dissolving the degradable polymer chosen. The choice of the first solvent should depend on the degradable polymer used in a particular embodiment and the second solvent chosen. The first solvent should be included in an amount sufficient to form a degradable polymer solvent mixture that can be mixed with a second solvent to form a solid-liquid dispersion. In certain embodiments, the amount of first solvent included will range from about 5% to about 80% based on the amount of the degradable polymer that is included in the degradable polymer solvent mixture. In one example of one embodiment wherein poly(lactic acid) is used, a propylene carbonate first solvent may be used in an amount of 50% to 80% based on the weight of poly(lactic acid) used.

The second solvent should be chosen in the precipitation methods relative to the first solvent such that the first solvent is soluble in the second solvent. Preferred second solvents are aqueous-based. Suitable aqueous-based second solvents may comprise a water source such as fresh water, saltwater (e.g., water containing one or more salts dissolved therein), brine (e.g., saturated saltwater), or seawater. Generally, the water source can be from any source, provided that it does not contain an excess of compounds that may adversely affect the process or the formation of degradable particulates. Potentially problematic compounds to be mindful of will be evident to one skilled in the art with the benefit of this disclosure. Examples of nonaqueous second solvents that may be used include ethanol, isopropanol, or a polyhydric alcohol (such as glycerol or water soluble solvents). As stated above, the second solvent may be a treatment fluid that will be introduced into the subterranean formation (e.g., a fracturing fluid, a gravel pack fluid, a drilling fluid, etc.). Thus, in such embodiments, the resultant degradable particulates may be introduced into the subterranean formation with the second solvent, which would be the treatment fluid used in that particular subterranean application. The second solvent should be included in an embodiment of the precipitation methods of this invention in an amount sufficient to form the solid-liquid dispersion and allow the degradable particulates to form. The amount of second solvent to use may vary depending on certain factors, for example, the identity of the first solvent; the quantity of the degradable polymer solvent mixture; the desired characteristics of the resultant degradable particulates; the concentration of the degradable polymer solvent mixture in the second solvent; the concentration of the degradable polymer in the degradable polymer solvent mixture, and the amount of degradable particulates to be produced. In some embodiments, the amount of second solvent to include may be less than about 1% to more than about 95% relative to the mixture. To ensure that desirable degradable particulates form, the degradable polymer should not be soluble in the second solvent.

If desired, optionally additives such as oxidizers, salts, or other chemical agents may be included in the degradable polymer solvent mixture such that when the degradable particulates form, the additives are incorporated within the particulates. Any additive that is capable of becoming incorporated into the degradable particulates during the precipitation process may be used. Preferably the additive should not be soluble in the first solvent, the second solvent, or the liquid phase of the solid-liquid dispersion. Any such additives may have a specific desirable functionality. For example, some additives may modulate the rate of hydrolysis of the degradable particulates depending on the conditions encountered in the particular application. Including an additive may be desirable when it would be beneficial to introduce the additive into the subterranean formation upon or during degradation of the degradable particulates. When contemplating the addition of an additive, one should be mindful that the additive should not adversely affect other operations or components. In an example of an alternative embodiment, an acid-soluble solid material may be added to the degradable polymer solvent mixture so that the acid-soluble material becomes incorporated into the resultant degradable particulates. Examples of suitable acid-soluble solid materials include, but are not limited to, calcium carbonate and magnesium oxide. This may be desirable, for example, to neutralize the acid generated upon degradation of the degradable particulates, to modulate the hydrolysis of the degradable particulates, or to add crush strength to the degradable particulates.

In these embodiments, the average size distribution of the resultant degradable particulates may vary, depending on several factors. These factors include, the type of first solvent used, the type of second solvent used, the chemical interaction between the first solvent and the second solvent, the particular degradable polymer used, the molecular weight of the degradable polymer, the concentration of the degradable polymer in the degradable polymer solvent mixture; the amount of shear applied; the type of shearing device, the presence of various additives, the temperature conditions, etc.

### The Melt Coagulation Methods of This Invention

The melt coagulation methods of the present invention may be used to produce degradable particulates of a suitable or desirable size and shape at the drill site for use in subterranean applications. The degradable particulates can be used in a subterranean application with or without a treatment fluid, depending on the use.

A melt coagulation method of this invention comprises the steps of providing a degradable polymer melt; atomizing the degradable polymer melt into an atomization fluid stream; and allowing degradable particulates to form.

The degradable polymer melt may be formed by heating a degradable polymer to at or above its melting point. The degradable polymer melt may be formed at the drill site or brought to the drill site (e.g., in a heated tanker truck). Any suitable device to produce or provide a degradable polymer melt at the drill site may be used in the melt coagulation methods of this invention. Shear may be incorporated into such a device, if desired.

During the atomization step, the degradable polymer melt is atomized into a atomization fluid stream in which the degradable polymer is not soluble. The atomization fluid stream may comprise a gas or a liquid, depending on the particular application. Pressure may be desirable to encourage the melt to proceed through the atomization device. Any suitable atomization device may be used in the melt coagulation methods of the present invention. One example of a suitable atomization device is a nozzle that has an appropriate diameter to produce degradable particulates having a desired shape or size. In some embodiments, the same sort of equipment used in applications to spray hot melt adhesives may be used. The degradable polymer melt may be atomized into an atomization fluid stream, which may comprise a liquid and/or a gas. The atomization fluid stream may comprise a treatment fluid in which the degradable particulates will be introduced into a subterranean formation for a desired application. In choosing the appropriate atomization fluid stream, one should be mindful that the degradable particulates should not be soluble in the atomization fluid stream. The desired concentration of degradable particulates in a treatment fluid may govern what type of fluid is used in the atomization fluid stream, including whether atomizing into a treatment fluid is appropriate. During this step, one should be mindful that the atomization should be done in such a manner that whole droplets of a desired size and shape are formed so that the resultant degradable particulates will have the desired shape and size. Atomization may occur in any suitable apparatus. A fluidized bed reactor is an example of a suitable apparatus. A high pressure nozzle is another example of a suitable apparatus. Preferred apparatus have a sufficient amount of fluid and the temperature is low enough to allow the degradable particulates to cool and form degradable particulates. The temperature and pressure at which the atomization is accomplished may impact greatly the size and shape of the resultant degradable particulates. Other factors that can affect the qualities of the resultant degradable particulates include the particular atomization device, the orifice of the atomization device, the temperature of the melt, the temperature and pressure conditions of the atomization process, etc.

If desired, optionally, the degradable polymer melt may comprise additional additives as long as they are not sensitive to or negatively impacted by the heating of the melt. Any such additives also should not negatively impact the degradable polymer melt itself, the atomization process or the formation of degradable particulates. Examples of suitable additives include oxidizers, salts, or other chemical agents that are desirable to have incorporated in the resultant degradable particulates. Any additive that is capable of becoming incorporated into the degradable particulates during a melt coagulation process may be used. Any such additives may have a specific desirable functionality. For example, some additives may modulate the rate of hydrolysis of the degradable particulates depending on the conditions encountered in the particular application. Including an additive may be desirable when it would be beneficial to introduce the additive into the subterranean formation upon or during degradation of the degradable particulates. When contemplating the addition of an additive, one should be mindful that the additive should not adversely affect other operations or components. In an example of an alternative embodiment, an acid-soluble solid material may be added to the degradable polymer melt so that the acid-soluble material becomes incorporated into the resultant degradable particulates. Examples of suitable acid-soluble solid materials include, but are not limited to, calcium carbonate and magnesium oxide. This may be desirable, for example, to neutralize the acid generated upon degradation of the degradable particulates, to modulate the hydrolysis of the degradable particulates, or to add crush strength to the degradable particulates.

Although all of the degradable polymers discussed above with respect to the emulsion and precipitation methods may be used in the melt coagulation methods of this invention, the particular degradable polymer chosen for a melt coagulation method preferably has a relatively lower molecular weight and melt viscosity. Also, degradable polymers that will form droplets upon atomization are preferred. Examples of suitable degradable polymers that may be used in conjunction with the emulsion methods of this invention include, but are not limited to, aliphatic polyesters; poly(lactides); poly(hydroxy ester ethers); poly(glycolides); poly(ε-caprolactones); poly(hydroxybutyrates); poly(anhydrides); polycarbonates; poly(orthoesters); poly(amino acids); poly(ethylene oxides); poly(phosphazenes); poly ether esters; polyester amides; polyamides; and copolymers or blends of any of these degradable polymers. Preferred examples of degradable polymers for use in the melt coagulation methods of this invention include poly(lactides), poly(glycolides), poly(ε-caprolactones), and poly(hydroxybutyrates). Other degradable polymers that are subject to hydrolytic degradation also may be suitable.

Plasticizers may be included in the degradable polymers to achieve desired properties in the resultant degradable particulates or the degradable polymer melt. Any of the above listed plasticizers are suitable for use in the melt coagulation methods of this invention as long as they are tolerant to the melt and atomization processes such that the plasticizer remains in the resultant degradable particulates to provide desired properties. The choice of plasticizer(s) will depend on the particular degradable polymer chosen for a particular embodiment of these melt coagulation methods and the application in which the degradable particulates will be used. In some embodiments, plasticizers may be particularly helpful to increase the melt viscosity and improve atomization of the melt.

One should note that if the resultant degradable particulates will be used in conjunction with a nonaqueous treatment fluid, the melt coagulation methods of this invention may be preferred as long as the nonaqueous fluid does not dissolve the degradable particulates.

In certain embodiments, it may be desirable to include a surfactant in the atomization fluid. The surfactant may help disperse the degradable particulates in the atomization fluid. Examples of suitable surfactants include any cationic, anionic, or nonionic surfactant capable of helping disperse the degradable particulates in the atomization fluid. Specific examples include, but are not limited to, sodium dodecyl sulfate, poly(vinyl alcohol), sodium dodecylbenzenesulfonic acid, cetyltrimethylammonium bromide, cetylpyridinium bromide, hexadecylmaltoside, Triton™ X-100, Tween™ 20, Brij W1, and Tergitol™ NP-40. The choice of which particular surfactant to use may be determined by the particular degradable polymer chosen, the melt conditions, and the atomization process chosen. In certain embodiments, the surfactant should be included in an amount sufficient to prevent degradable particulate agglomeration. In some embodiments, this may be from about 0.1% to about 5% based on the amount of degradable particulates in the atomization fluid.

The particle size of the degradable particulates can be altered by changing various factors in the process. For instance, the melt temperature, the particular atomization device, the conditions encountered in the atomization device (e.g., temperature and pressure), the rate at which the atomization occurs, additives, and the like may all be altered to produce degradable particulates having differing sizes and/or characteristics. One of ordinary skill in the art with the benefit of this disclosure will recognize the variables and the degree of variation required to produce the degradable particulates for use in a particular application.

### The Supercritical Fluid Assisted Methods of This Invention

The supercritical fluid assisted methods of the present invention may be used to produce degradable particulates of a suitable or desirable size and shape at the drill site for use in subterranean applications. The degradable particulates can be used in a subterranean application with or without a treatment fluid, depending on the use. These supercritical fluid assisted methods may be especially useful for forming smaller degradable particulates. For instance, in certain embodiments, these methods may be used to produce 1 to 3 μm degradable particulates that may have a lower tendency to agglomerate.

Although other supercritical fluids may be suitable, supercritical carbon dioxide is a preferred supercritical fluid in these methods. Generally speaking, the use of a supercritical carbon dioxide is desirable because it is considered an environmentally friendly solvent substitute. Carbon dioxide is considered to be nontoxic, nonflammable, and has easily accessible critical conditions, i.e., T_{c}=31° C. and P_{c}=7.37 MPa.

An example of a supercritical fluid assisted method of this invention is a method of forming degradable particulates at a drill site that comprises: providing a degradable polymer supercritical fluid mixture; allowing the degradable polymer supercritical fluid mixture to expand through an orifice into a lower pressure zone; and allowing degradable particulates to form. The lower pressure zone may be any suitable lower pressure area including, but not limited to, a chamber in a piece of equipment, a fluid, a treatment fluid in which the resultant degradable particulates will be introduced into a subterranean formation, or the like. The degradable polymer supercritical fluid mixture may be mixed at the drill site or premixed at a second location and then brought to the drill site.

In alternative embodiments, a suitable solvent and/or a surfactant may be incorporated into the degradable polymer supercritical fluid mixture, for example, when the degradable polymer is not sufficiently soluble in the supercritical fluid without the solvent or surfactant. Any solvent or surfactant that will aid in the dissolution of the degradable polymer in the supercritical carbon dioxide is suitable. Preferred solvents and surfactants also are compatible with the circumstances surrounding the particular subterranean application of the degradable particulates. The particular solvent or surfactant used depends in large part on the identity of the degradable polymer chosen for a specific embodiment.

The choice of an optional solvent for the degradable polymer supercritical fluid mixture in the emulsion methods of this invention will depend, inter alia, on the particular degradable polymer chosen, the concentration of the degradable polymer in the supercritical degradable polymer mixture, etc. Examples of suitable solvents include, but are not limited to, acetone, chloroform, dichloromethane, 1,2-dichlorobenzene, tetrahydrofuran, benzene, acetonitrile, dioxane, dimethylform amide, toluene, ethyl acetate, N-methylpyrrolidone, xylene, ether, diphenyl ether, ethylbenzene, naphthalene, propylene carbonate, di(propylene glycol) methyl ether, di(propylene glycol) propyl ether, di(propylene glycol) butyl ether, di(propylene glycol) methyl ether acetate, derivatives thereof, and combinations thereof. Fluorinated alcohols and fluorinated hydrocarbons may be especially useful, depending on the particular degradable material chosen and the conditions of the particular application. In choosing a solvent to use in an embodiment of a supercritical fluid assisted method of this invention, one should be mindful of the properties of that solvent and any regulations that may apply, especially if the degradable particulates will be made on-the-fly, which could result in at least some of the solvent being introduced into a subterranean formation. Other considerations to be taken into account when choosing a solvent include safety and industrial hygiene, any potential environmental issues, potential safety issues in terms of flash point and potential exposure, and relative cost. If used, the solvent should be included in an amount sufficient to aid in the formation of the degradable polymer supercritical fluid mixture.

Examples of suitable optional surfactants that may be used in these methods include any cationic, anionic, or nonionic surfactant. Specific examples include, but are not limited to, sodium dodecyl sulfate, poly(vinyl alcohol), sodium dodecylbenzenesulfonic acid, cetyltrimethylammonium bromide, cetylpyridinium bromide, hexadecylmaltoside, Triton™ X-100, Tween™ 20, Brij W1, and Tergitol™ NP-40. The choice of which particular surfactant to use may be determined by the particular degradable polymer chosen. In certain embodiments, the surfactant should be included in an amount sufficient to stabilize the degradable polymer supercritical fluid mixture. In some embodiments, this may be from about 0.1% to about 5% based on the amount of degradable polymer in a degradable polymer supercritical fluid mixture.

All of the degradable polymers discussed above with respect to the emulsion, precipitation, and melt coagulation methods may be used in the supercritical fluid assisted methods of this invention. Examples include, but are not limited to, aliphatic polyesters; poly(lactides); poly(glycolides); poly(ε-caprolactones); poly(hydroxybutyrates); poly(anhydrides); polycarbonates; poly(orthoesters); poly(amino acids); poly(ethylene oxides); poly(phosphazenes); polyether esters; polyester amides; polyamides; and copolymers or blends of any of these degradable polymers. Plasticizers may be included in the degradable polymers to achieve the desired properties. Any plasticizer is suitable as long as it is not negatively impacted by or does not negatively impact the formation of the degradable particulates. In choosing the particular degradable polymer for a chosen application, one should note that some of the degradable polymers may have lower solubility in supercritical carbon dioxide than others. This relative solubility should be taken into account when mixing or providing a degradable polymer supercritical fluid mixture. As stated above, solvents or surfactants may be included if needed.

Allowing the degradable polymer supercritical fluid mixture to expand through an orifice into a lower pressure zone may be accomplished by any suitable method. The degradable polymer supercritical fluid mixture may be allowed to expand through a suitable nozzle, for example, into a zone having a lower pressure. One should note that the pressure and temperature conditions used in the expansion step may affect the size and properties of the resultant degradable particulates. The geometry of the orifice also can greatly affect the characteristics of the resultant degradable particulates. The concentration of the degradable polymer in the degradable polymer supercritical fluid mixture also may affect the properties of the resultant degradable particulates. The lower pressure zone may be internal to or external to a well bore in subterranean formation. In some embodiments, the lower pressure zone may comprise a treatment fluid in which the degradable particulates will be introduced into a subterranean formation.

### Examples of Suitable Subterranean Applications

The degradable particulates can be used in a subterranean application with or without a treatment fluid, depending on the particular application and the surrounding circumstances. One of ordinary skill in the art with the benefit of this disclosure will be able to recognize when the degradable particulates should be or should not be used in conjunction with a treatment fluid. One consideration is the ability to incorporate the degradable particulates in the treatment fluid. Another consideration is the timing desired for the degradation of the degradable particulates. Another consideration is the concentration of degradable particulates needed in a chosen treatment fluid.

The degradable particulates made by any method of this invention may be used in any suitable subterranean application. Depending on the particular use, the degradable particulates may have several purposes. The first is to create voids upon degradation. A second is to release certain desirable degradation products that may then be useful for a particular function. Another reason is to temporarily restrict the flow of a fluid. Examples of subterranean applications in which the generated degradable particulates could be used include, but are not limited to, such applications as fluid loss control particles, as diverting agents, as filter cake components, as drilling fluid additives, as cement composition additives, or other acid-precursor components. Specific nonlimiting embodiments of some examples are discussed below.

In some methods, the degradable particulates may be used to increase the conductivity of a fracture. This may be accomplished by incorporating the degradable particulates into a fracturing fluid comprising proppant particulates, allowing the proppant particulates to form a proppant matrix within a fracture that comprises the degradable particulates, and allowing the degradable particulates to degrade to form voids within the proppant matrix. The term “proppant matrix” refers to some consolidation of proppant particulates.

In another example of a subterranean application, the degradable particulates may be used to divert a fluid within a subterranean formation.

In another example, the degradable particulates may be used in a composition designed to provide some degree of sand control to a portion of a subterranean formation. In an example of such a method, the degradable particulates may be incorporated into a cement composition which is placed down hole in a manner so as to provide some degree of sand control. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated into a cement composition to be used in a primary cementing operation, such as cementing casing in a well bore penetrating a subterranean formation. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated in a gravel pack composition. Upon degradation of the degradable particulates, any acid-based degradation products may be used to degrade an acid-soluble component in the subterranean formation, including but not limited to a portion of a filter cake situated therein.

In another example, the degradable particulates may be incorporated with a viscosified treatment fluid (e.g., a fracturing fluid or a gravel pack fluid) to act as a breaker for the viscosified treatment fluid (i.e., at least partially reduce the viscosity of the viscosified treatment fluid).

In another example, the degradable particulates may be used as self-degrading bridging agents in a filter cake.

In another example, the degradable particulates may be used as a fluid loss control additive for at least partially controlling or minimizing fluid loss during a subterranean treatment such as fracturing.

In another example, the degradable particulates may be used in conjunction with cleaning or cutting a surface in a subterranean formation.

Therefore, the present invention is well adapted to attain the ends and advantages mentioned as well as those that are inherent therein. While numerous changes may be made by those skilled in the art, such changes are encompassed within the spirit of this invention as defined by the appended claims.

What is claimed is:

1. A method comprising:
providing a degradable polymer solvent mixture that comprises a degradable polymer and a first solvent;
adding the degradable polymer solvent mixture to a second solvent with sufficient shear to form an emulsion at a drill site, the emulsion comprising a discontinuous phase and a continuous phase, the discontinuous phase comprising the degradable polymer solvent mixture and the continuous phase comprising the second solvent;
removing a sufficient amount of the first solvent from the discontinuous phase so that degradable particulates begin to form; and
allowing a dispersion of degradable particulates to form in the continuous phase.

2. The method of claim 1 further comprising the step of introducing at least a portion of the degradable particulates into a subterranean formation.

3. The method of claim 1 wherein removing a sufficient amount of the first solvent from the discontinuous phase is accomplished by a method comprising at least one of the following: vacuum stripping, steam stripping, or evaporation.

4. The method of claim 1 wherein forming the emulsion involves using a high speed disperser, a jet nozzle, or an in-line mixer.

5. The method of claim 1 wherein the second solvent comprises a treatment fluid in which the degradable particulates will be introduced into a subterranean formation.

6. The method of claim 1 wherein the degradable polymer solvent mixture is formed by forming a degradable monomer solvent mixture, and then heating the degradable monomer solvent mixture to a sufficient degree to form the degradable polymer solvent mixture.

7. The method of claim 1 wherein the degradable polymer comprises at least one of the following: an aliphatic polyester; a poly(lactide); a poly(hydroxy ester ether); a poly(glycolide); a poly(ε-caprolactone); a poly(hydroxybutyrate); a poly(anhydride); an aliphatic polycarbonate; a poly(orthoester); a poly(amino acid); a poly(ethylene oxide); a poly(phosphazene); a polyether ester; a polyester amide; a polyamide; a copolymer or blend thereof.

8. The method of claim 1 wherein the degradable polymer comprises a plasticizer.

9. The method of claim 1 wherein the emulsion comprises an emulsifying surfactant that comprises at least one of the following: a cationic surfactant, an anionic surfactant, or a nonionic surfactant.

10. The method of claim 1 wherein the first solvent comprises at least one of the following: acetone, chloroform, dichloromethane, 1,2-dichlorobenzene, tetrahydrofuran, benzene, acetonitrile, dioxane, dimethylformamide, toluene, ethyl acetate, N-methylpyrrolidone, xylene, ether, diphenyl ether, ethylbenzene, naphthalene, propylene carbonate, di(propylene glycol) methyl ether, di(propylene glycol) propyl ether, di(propylene glycol) butyl ether, di(propylene glycol) methyl ether acetate, a derivative thereof, or a combination thereof.

11. The method of claim 1 wherein the degradable polymer solvent mixture comprises at least one of the following: an oxidizer, a salt, or an acid-soluble material.

12. The method of claim 1 further comprising:
incorporating at least a portion of the degradable particulates into a fracturing fluid that comprises proppant particulates;
allowing a portion of the proppant particulates to form a proppant matrix that comprises at least a plurality of the degradable particulates within a fracture in a subterranean formation; and
allowing the degradable particulates to degrade so as to form at least one void in the proppant matrix.

13. The method of claim 1 further comprising using at least a portion of the degradable particulates in a subterranean application to divert a fluid within the subterranean formation or act as a fluid loss control agent in a subterranean application.

14. The method of claim 1 further comprising placing at least a portion of the degradable particulates in a cement composition that comprises a hydraulic cement and water.

15. The method of claim 1 further comprising the step of incorporating at least a portion of the degradable particulates into a gravel pack.

16. The method of claim 1 further comprising the step of incorporating at least a portion of the degradable particulates into a viscosified treatment fluid, the degradable particulates being capable of acting as a viscosity breaker for the viscosified treatment fluid.

17. The method of claim 1 further comprising incorporating at least a portion of the degradable particulates into a filter cake, the degradable particulates being capable of acting as degradable bridging agents in the filter cake.

18. A method of forming degradable particulates comprising:
providing a degradable polymer solvent mixture at a drill site that comprises a degradable polymer and a first solvent;
adding a second solvent to the degradable polymer solvent mixture with sufficient shear to form a first emulsion, the first emulsion comprising a discontinuous phase that comprises the second solvent and a continuous phase that comprises the degradable polymer solvent mixture;
continuing to add the second solvent to the first emulsion until a second emulsion forms, the second emulsion comprising a discontinuous phase that comprises the degradable polymer solvent mixture and a continuous phase that comprises the second solvent;
removing the first solvent from the discontinuous phase of the second emulsion so that degradable particulates begin to form; and
allowing a dispersion of degradable particulates to form in the continuous phase of the second emulsion.

19. A method comprising:
providing a degradable polymer solvent mixture that comprises a degradable polymer and a first solvent;
adding the degradable polymer solvent mixture to a second solvent with sufficient shear to form an emulsion at a drill site, the emulsion comprising a discontinuous phase and a continuous phase, the discontinuous phase comprising the degradable polymer solvent mixture and the continuous phase comprising the second solvent; and
allowing a dispersion of degradable particulates to form in the continuous phase.

20. A method comprising:
providing a treatment fluid at a drill site, the treatment fluid comprising degradable particulates, at least a portion of the degradable particulates having been made by an emulsion method at the drill site; and
introducing the treatment fluid into a well bore penetrating a subterranean formation at the drill site.
